(19) United States
(12) Patent Application Publication
(10) Pub. No.: US 2015/0078618 A1
(43) Pub. Date: Mar. 19, 2015

(54) SYSTEM FOR TRACKING DANGEROUS SITUATION IN COOPERATION WITH MOBILE DEVICE AND METHOD THEREOF

(71) Applicant: ELECTRONICS AND TELECOMMUNICATIONS RESEARCH INSTITUTE, Daejeon (KR)

(72) Inventor: Moo-Seop KIM, Sejong (KR)

(73) Assignee: ELECTRONICS AND TELECOMMUNICATIONS RESEARCH INSTITUTE, Daejeon (KR)

(21) Appl. No.: 14/273,752

(22) Filed: May 9, 2014

(30) Foreign Application Priority Data
Sep. 17, 2013 (KR) 10-2013-0111919

(51) Int. Cl. G08B 13/196; G06K 9/46; G06K 9/00

(52) U.S. Cl. CPC G08B 13/19608; G06K 9/00771; G06K 9/46
USPC 382/103

(57) ABSTRACT

A system for tracking dangerous situation in cooperation with a mobile device and method thereof are provided. The system comprises: a first surveillance device installed in a predetermined surveillance area, obtaining image data relating to a target causing dangerous situation and providing the obtained image data; and a control center receiving the image data from the first surveillance device, and when it is determined based on the received image data that dangerous situation occurs, extracting feature data from the image data and transmitting metadata including the extracted feature data to at least one second surveillance device located on neighboring surveillance areas.

### CROSS REFERENCE TO RELATED APPLICATION

This application claims the benefit of Korean Patent Application No. 10-2013-0111919, filed on Sep. 17, 2013, entitled “System for tracking dangerous situation in cooperation with mobile device and method thereof”, which is hereby incorporated by reference in its entirety into this application.

### BACKGROUND OF THE INVENTION

1. Technical Field

The present invention relates to a method for tracking dangerous situation and more particularly, to a system and a method for tracking dangerous situation in cooperation with mobile devices to detect harmful or dangerous situation in which the system can determine harmful or dangerous situation based on image data transmitted from a surveillance camera or a mobile device and notify harmful or dangerous situation based on the determined result to surveillance cameras and mobile devices located around the corresponding surveillance area so that the surveillance cameras and the mobile devices, which received the result, can cooperate each other to detect harmful or dangerous situation.

2. Description of the Related Art

Recent risk detection technology uses a method including transmitting image data obtained from number of surveillance cameras to an integrated control center, checking the image data transmitted in real-time from number of surveillance cameras with controllers' naked eyes, and determining harmful/dangerous situation to take confrontational action to the harmful/dangerous situation.

However, image data to be determined is too rapidly increasing to determine harmful/dangerous situation with the naked eyes due to network developments. It is practically difficult to determine a huge volume of image data for harmful/dangerous situation in real-time since fatigue of the controllers becomes high after a certain time.

In order to resolve such problems, has an intelligent image analysis technology been introduced so that image data transmitted through number of surveillance cameras can be automatically analyzed, and when harmful/dangerous situation occurs, it automatically notifies to a control center. Then, the control center intensively analyzes the image data of the surveillance camera in which an alarm rings to efficiently respond to the harmful/dangerous situation.

However, a surveillance camera, which is a device obtaining image data, is too expensive to be installed in all areas and further, the intelligent image analysis technology applied to control centers and surveillance cameras practically has high ratio for false detection and false-positive detection for harmful/dangerous situation so that it is difficult to be utilized efficiently to detect harmful/dangerous situation.

### SUMMARY

An object of the present invention is to provide a system and a method for tracking dangerous situation in cooperation with a mobile device in which the system determines harmful or dangerous situation based on the image data transmitted from a surveillance camera or a mobile device and notifying the determined harmful or dangerous situation to surveillance cameras and mobile devices located on neighboring surveillance areas so that the surveillance cameras and the mobile devices, which received the result, cooperate each other to detect harmful or dangerous situation.

However, it is to be appreciated that the object of the present invention is not limited to the object described above and other objects which are not described will be understood from the description which will be described hereinafter by those skilled in the art.

According to an aspect of the present invention, in order to achieve the objects of the present invention, there is provided a system for tracking dangerous situation comprising: a first surveillance device installed in a predetermined surveillance area, obtaining image data relating to a target causing dangerous situation and providing the obtained image data; and a control center receiving the image data from the first surveillance device, and when it is determined based on the received image data that dangerous situation occurs, extracting feature data from the image data and transmitting metadata including the extracted feature data to at least one second surveillance device located on neighboring surveillance areas.

In one embodiment, the first surveillance device and the second surveillance device comprise at least one of a surveillance camera and a mobile device obtaining image data.

In one embodiment, the first surveillance device, when the image data within the surveillance area is obtained, provides the obtained image data and its location information to the control center.

In one embodiment, the location information comprises at least one of global positioning system (GPS) location information and an identifier to identify a surveillance area.

In one embodiment, the control center, when it is determined that the dangerous situation occurs, calculates the neighboring surveillance areas where the target may move, extracts feature data from the extracted image data, and transmits metadata including the extracted feature data to the second surveillance device located on the neighboring surveillance areas. In one embodiment, the second surveillance device, when the metadata is received from the control center, extracts feature data from the received metadata and determines if the extracted feature data is present in currently inputted image data.

In one embodiment, the second surveillance device, when the result is determined as that the feature data is present in the image data, generates detection result data including current location information and the image data in which the feature data is present and transmits the generated detection result data to the control center to inform that the target has moved to the corresponding surveillance area(s).

In one embodiment, the detection result data comprises a numerical value representing congruence or degree of similarity with the feature data to determine if the feature data is present or not.

According to another aspect of the present invention, there is provided a method for tracking dangerous situation comprising: providing image data relating to a target causing dangerous situation within a predetermined surveillance area in which the image data is obtained by a first surveillance device installed in the predetermined surveillance area; and transmitting, when a control center receives the image data from the first surveillance device, determines based on the received image data if dangerous situation occurs, and extracts feature data from the image data when it is determined as that dangerous situation occurs, metadata including the extracted feature data to at least one second surveillance device located on neighboring surveillance areas.

In one embodiment, the first surveillance device and the second surveillance device comprise at least one of a surveillance camera and a mobile device obtaining image data.

In one embodiment, the providing of the image data relating to the target, when the image data within the surveillance area is obtained, comprises providing the obtained image data and its location information to the control center.

In one embodiment, the location information comprises at least one of global positioning system (GPS) location information and an identifier to identify a surveillance area.

In one embodiment, the transmitting, when it is determined as that the dangerous situation occurs, comprises calculating the neighboring surveillance areas where the target may move, extracting feature data from the extracted image data, and transmitting metadata including the extracted feature data to the second surveillance device located on the neighboring surveillance areas.

In one embodiment, the method further comprises: receiving, by the second surveillance device, the metadata from the control center and extracting feature data from the received metadata and determining, by the second surveillance device, if the extracted feature data is present in currently inputted image data.

In one embodiment, the method further comprises: generating, by the second surveillance device, detection result data including current location information and the image data in which the feature data is present, when it is determined that if the extracted feature data is present in currently inputted image data; and transmitting the generated detection result data to the control center to inform that the target has moved to the corresponding surveillance area.

In one embodiment, the detection result data comprises a numerical value representing congruence or degree of similarity with the feature data to determine if the feature data is present or not.

Accordingly, the present invention allows efficient detection for harmful or dangerous situation with reduced detection errors by determining harmful or dangerous situation based on the image data transmitted from a surveillance camera or a mobile devices, notifying the harmful or dangerous situation based on the determined result to surveillance cameras and mobile devices located around the corresponding surveillance area, and letting the surveillance cameras and the mobile devices, which received the result, cooperate each other.

Furthermore, the present invention allows tracking for or responding to a target causing dangerous situation in real-time since harmful or dangerous situations are detected through the cooperation between surveillance cameras and mobile devices.

### BRIEF DESCRIPTION OF THE DRAWINGS

FIG. 1 is a diagram illustrating a system for tracking dangerous situation according to an embodiment of the present invention.

FIG. 2a to FIG. 2c are diagrams for explaining the principle for detection of dangerous situation according to an embodiment of the present invention.

FIG. 3 illustrates a configuration of a control center according to an embodiment of the present invention.

FIG. 4 illustrates a configuration of a mobile device and a surveillance camera according to an embodiment of the present invention.

FIG. 5 is a flowchart illustrating a method for tracking dangerous situation according to an embodiment of the present invention.

### DESCRIPTION OF THE EXEMPLARY EMBODIMENTS

Hereinafter, a system and a method for tracking dangerous situation of the present invention will be described with reference to the accompanying drawings. It will be explained in more detail with the parts needed to understand operations and functions of the present invention.

In the description for components of the present invention, components having the same name may be denoted by the same reference numerals in different drawings or by different reference numerals according the drawings. However, it does not mean that the corresponding component has a different function according to embodiments or has the same function according to different embodiments. Each function of components will be determined based on the description for each component in embodiments.

Particularly, the present invention provides a new method for detecting harmful or dangerous situation which comprises determining harmful or dangerous situation based on image data transmitted from a surveillance camera or a mobile device, notifying harmful or dangerous situation based on the determined result to surveillance cameras and mobile devices installed around the corresponding surveillance area, and letting the surveillance cameras and the mobile devices cooperate each other to detect harmful or dangerous situation.

Generally, surveillance cameras are installed to detect harmful or dangerous situation. However, it is not possible to detect all areas with a limited number of surveillance cameras and there are also dead angle areas such as directly below the camera or by-roads where detection can be difficult. Thus, a user is going to detect harmful or dangerous situation which can occur in such dead angle areas by cooperating with mobile devices.

For example, when a user sees harmful or dangerous situation occurred in a dead angle area, the user can take pictures or video for that situation and transmits the result to a control center.

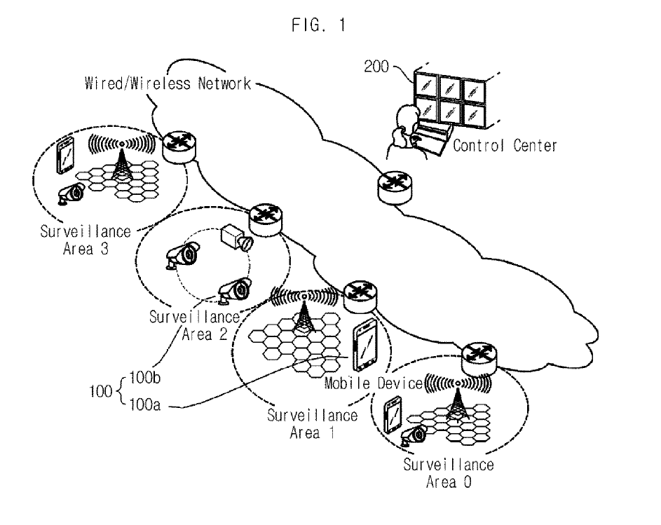

FIG. 1 is a diagram illustrating a system for tracking dangerous situation according to an embodiment of the present invention.

As shown in FIG. 1, s system for tracking dangerous situation according to the present invention can be configured to include surveillance device 100 such as a mobile device 100a and a surveillance camera 100b and a control center 200.

The mobile device 100a may obtain image data and transmit the obtained image data and its location information to the control center 200 through wired network or wireless network. Here, the mobile device 100a may be an electronic device which a user can use while moving such as smartphones, tablet PCs, personal digital assistants (PDAs), notebooks and the like.

The location information may be global positioning system location information.

The mobile device 100a may receive metadata from the control center 200 to determine harmful or dangerous situation, extract feature data from the received metadata, determine if a tracking target present in the feature data is in the image data obtained through the camera based on the extracted feature data, and transmits the determined result to the control center 200.

The surveillance camera 100b may obtain image data and transmit the obtained image data and its location information to the control center 200 through wired network or wireless network.

The location information may be an identifier to identify a surveillance area.

The surveillance camera 100b may receive metadata from the control center 200 to determine harmful or dangerous situation, extract feature data from the received metadata, determine if a tracking target present in the feature data is in the image data obtained through the camera based on the extracted feature data, and transmits the determined result to the control center 200.

The control center 200 may receive event data including the image data and location information from the mobile device 100a and the surveillance camera 100b and determine if it is dangerous situation by analyzing the image data included in the event data. Here, the control center 200 may determine harmful or dangerous situation by using various programs which use intelligent image recognition technology or by controllers' naked eyes.

The control center 200, when it is determined as that harmful or dangerous situation occurs, may extract at least one feature data from the image data in the received event data and generate metadata including the extracted feature data.

For example, the control center 200 may generate metadata which can be location information, pictures, image to track the occurrence of the corresponding event such as harmful or dangerous situation.

Here, the metadata may include color information, physical features including face of the tracking target such as a particular person or thing, or features of goods which the tracking target holds.

The control center 200 may transmit the generated metadata to mobile devices 100a or surveillance cameras 100b located around the area where the harmful or dangerous situation has been caused. Here, the control center 200 may determine the area where the harmful or dangerous situation has been caused based on the location information included in the event data.

The control center 200 may be notified for that harmful or dangerous situation occurs from the mobile devices 100a or surveillance cameras 100b which are around the area where the harmful or dangerous situation has been caused based on the transmitted metadata.

The present invention is able to easily recognize and detect harmful or dangerous situation through not only a control center but also surveillance cameras or various types of mobile devices, which can be compared with conventional recognition and detection of harmful or dangerous situation which is performed by only the control center by collecting and analyzing image. Namely, according to the present invention, not only control center and surveillance cameras but also mobile platform-based mobile devices can be cooperated to detect harmful or dangerous situations even for the area which cannot be detected by conventional surveillance cameras and also to detect and respond to harmful or dangerous situations in real-time.

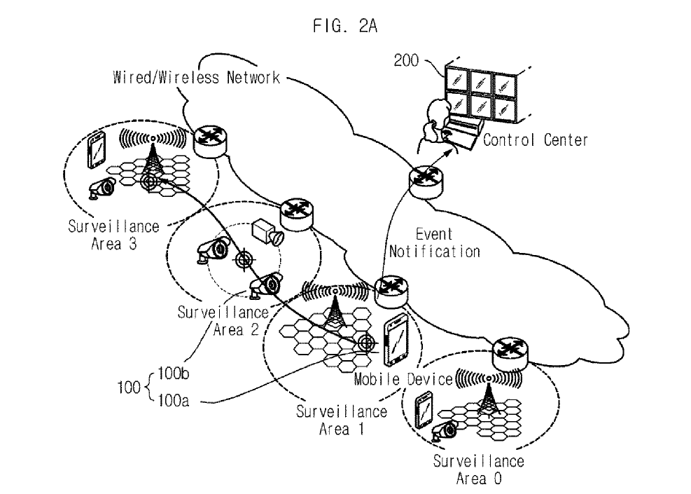

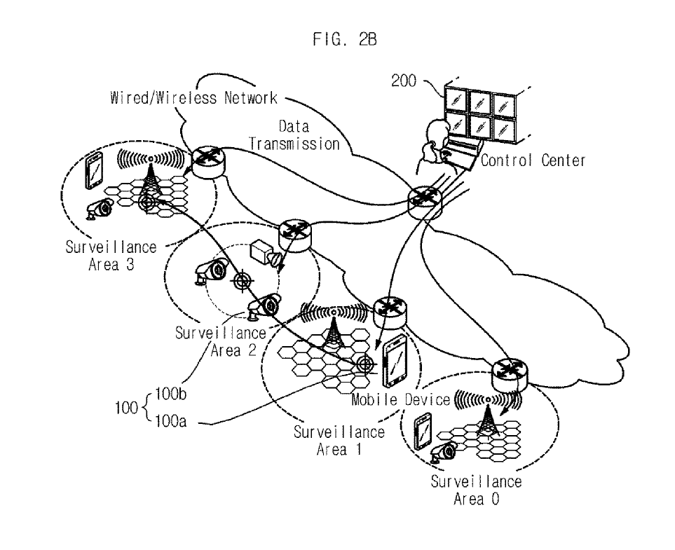

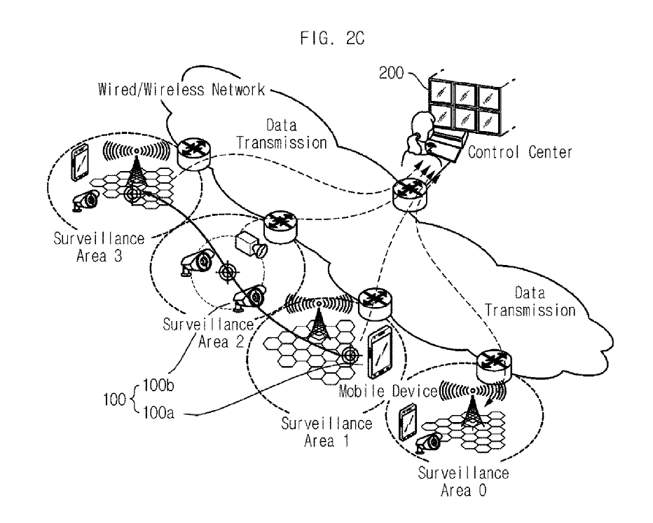

FIG. 2a to FIG. 2c are diagrams for explaining the principle for detection of dangerous situation according to an embodiment of the present invention.

Referring to FIG. 2a, when a mobile device 100a installed in a predetermined surveillance area 1 obtains image data which is determined as harmful or dangerous situation, it generates event data including the obtained image data and location information and transmits the generated event data to the control center 200.

Referring to FIG. 2b, the control center 200, after receiving the event data from the mobile device 100a, extracts image data and location data from the received event data and analyzes the extracted image data to determine if it is harmful or dangerous situation.

The control center 200, when it is determined as that harmful or dangerous situation occurs, extracts at least one feature data from the image data included in the received event data, generates metadata including the extracted feature data and transmits the generated metadata to mobile devices or surveillance cameras located on a surveillance area 0, a surveillance area 2 and a surveillance area 3 which are located around based on the location information of the surveillance area 1.

Such surveillance areas may be predetermined based on the locations where surveillance cameras are installed.

Referring to FIG. 2c, when the mobile device 100a or the surveillance camera 100b located on the surveillance area 0, the surveillance area 2 or the surveillance area 3 receives the metadata, it determines if the feature data included in the image data obtained from the corresponding area is present based on the feature data included in the received metadata and transmits the determined result to the control center 200.

For example, when a tracking target moves from the surveillance area 1 to the surveillance areas 2 and 3, it cannot be detected in the surveillance area 0 but it can be detected with high possibility by the surveillance camera or the mobile device in the surveillance area 2.

Since the tracking target has moved to surveillance area 2, detection result in the surveillance area 2 has the highest degree of similarity. Thus, the control center 200 generates new location information and metadata by updating the location information and metadata using the detection result received from the surveillance area 2 and then transmits the updated result again to the surveillance area 3 and the surveillance area 1 which are around the surveillance area 2.

When the tracking target moves further to the surveillance area 3 through the surveillance area 2, the surveillance camera or the mobile device in the surveillance area 3, which received the new location information and metadata, can transmit detection result having the highest degree of similarity with the metadata to the control center.

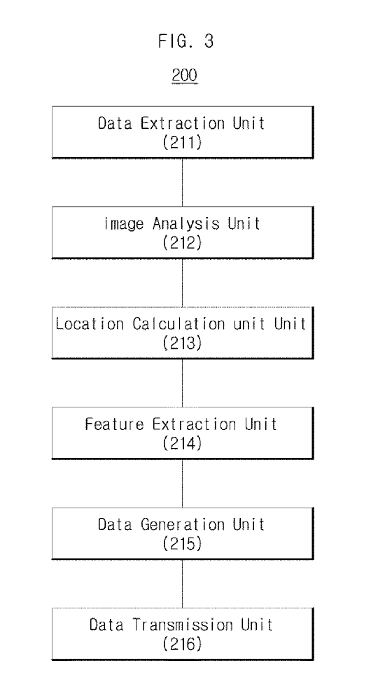

FIG. 3 illustrates a configuration of a control center according to an embodiment of the present invention.

As shown in FIG. 3, the control center 200 according to the present invention can include a data extraction unit 211, an image analysis unit 212, a location calculation unit 213, a feature extraction unit 214, a data generation unit 215, and a data transmission unit 216.

The data extraction unit 211 may extract image data and location information from event data received from the mobile device 100a or the surveillance camera 100b.

The image analysis unit 212 may determine if it is harmful or dangerous situation by analyzing the extracted image data.

The location calculation unit 213 may calculate neighboring surveillance areas where the tracking target may move based on the extracted location information.

The feature extraction unit 214 may extract feature data from the extracted image data.

The data generation unit 215 may generate metadata including the extracted feature data.

The data transmission unit 216 may transmit the generated metadata to mobile devices 100a or surveillance cameras 100b located around the surveillance area through wired network or wireless network.

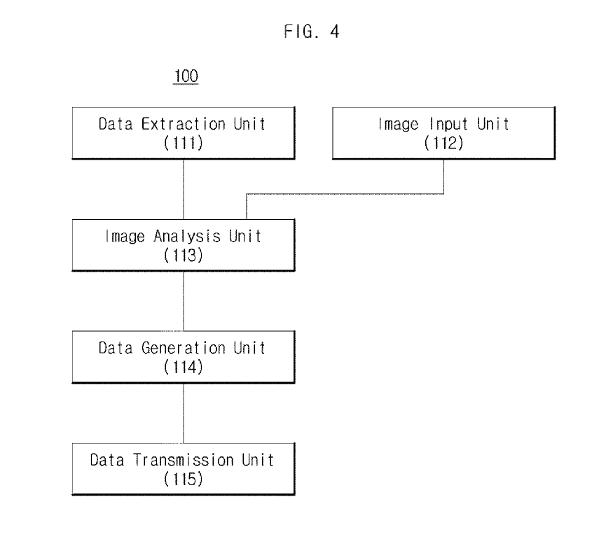

FIG. 4 illustrates a configuration of a mobile device and a surveillance camera according to an embodiment of the present invention.

As shown in FIG. 4, the surveillance device 100 such as mobile device 100a or surveillance camera 100b according to the present invention may include a data extraction unit 111, an image input unit 112, an image analysis unit 113, a data generation unit 114, and a data transmission unit 115.

The data extraction unit 111 may extract feature data from the metadata received from the control center 200.

The image input unit 112 may receive image data obtained by a camera.

The image analysis unit 113 may determine if a tracking target present in the feature data is in the image data obtained through the camera based on the extracted feature data. The image analysis unit 113 may use various intelligent image processing programs or similar programs thereto.

The image analysis unit 113 may install and use an analysis program necessary to mobile platform-based mobile devices or be input with visually determined result by a user.

The data generation unit 114, when the feature data exists in the image data, may generate detection result data including current location information and the received image data. Here, the detection result data may include a numerical value representing congruence or degree of similarity with the feature data to determine if the feature data is present or not.

The data transmission unit 115 may transmit the generated detection result data to the control center 200.

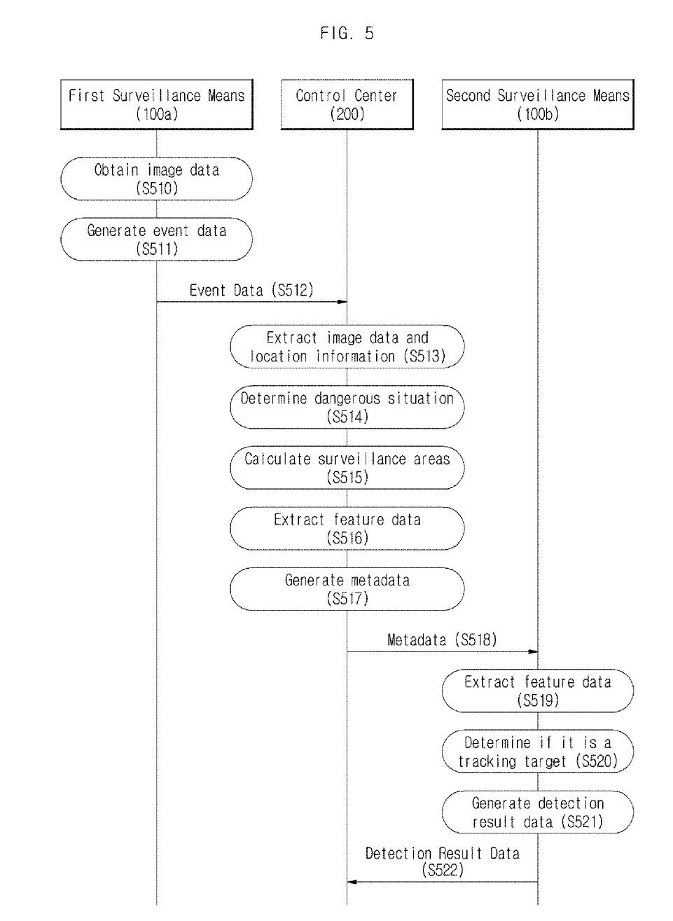

FIG. 5 is a flowchart illustrating a method for tracking dangerous situation according to an embodiment of the present invention.

As shown in FIG. 5, a first surveillance device such as mobile device 100a or surveillance camera 100b according to the present invention may obtain image data including a target or thing causing harmful or dangerous situation.

The surveillance device may generate event data including the obtained image data and its location information and transmit the generated event data to the control center 200.

The control center 200, when the event data is received, may extract image data and location information from the received event data and analyze the extracted image data to determine if it is harmful or dangerous situation.

The control center 200, when it is determined that harmful or dangerous situation occurs, may calculate neighboring surveillance areas where the tracking target may move based on the extracted location information and extract feature data from the extracted image data.

The control center 200 may generate metadata including the extracted feature data and transmit the generated metadata to the second surveillance device 100b such as mobile devices 100a or surveillance cameras 100b located around the surveillance area through wired or wireless network.

The second surveillance device may determine if a tracking target present in the feature data is in the image data input at the current location based on the extracted feature data.

For example, the surveillance camera may receive metadata from the control center and then transmit image data input based on the location information included in the received metadata or directly determine from the input image data if the tracking target is present.

The mobile device may detect around based on the received metadata and determine if a target or thing close to the metadata is present. The mobile device may use image analysis programs or tools in addition to a user's judgment.

The second surveillance device, when it determines as that the feature data is present in the image data, may generate detection result data including current location information and the relating image data which is the image data having feature data.

The second surveillance device 100b may transmit the generated detection result data to the control center 200.

Accordingly, the control center is able to respond to harmful or dangerous situation with reduced errors by collecting detection results received from surveillance areas, analyzing them statistically and tracking by using the detection result having stochastically the highest similarity.

Meanwhile, although it has been mentioned that all components configuring the exemplary embodiment of the present invention described hereinabove are combined with each other as one component or are combined and operated with each other as one component, the present invention is not necessarily limited to the above-mentioned exemplary embodiment. That is, all the components may also be selectively combined and operated with each other as one or more component without departing from the scope of the present invention. In addition, although each of all the components may be implemented by one independent hardware, some or all of the respective components which are selectively combined with each other may be implemented by a computer program having a program module performing some or all of functions combined with each other in one or plural hardware. In addition, the computer program as described above may be stored in computer readable media such as a universal serial bus (USB) memory, a compact disk (CD), a flash memory, or the like, and be read and executed by a computer to implement the exemplary embodiment of the present invention. An example of the computer readable media may include magnetic recording media, optical recording media, carrier wave media, and the like.

The spirit of the present invention has been described by way of example hereinabove, and the present invention may be variously modified, altered, and substituted by those skilled in the art to which the present invention pertains without departing from essential features of the present invention. Accordingly, the exemplary embodiments disclosed in the present invention and the accompanying drawings do not limit but describe the spirit of the present invention, and the scope of the present invention is not limited by the exemplary embodiments and accompanying drawings. The scope of the present invention should be interpreted by the following claims and it should be interpreted that all spirits equivalent to the following claims fall within the scope of the present invention.

### DESCRIPTION OF REFERENCE NUMERALS

100: surveillance device
100a: mobile device
100b: surveillance camera
111: data extraction unit
112: image input unit
113: image analysis unit
114: data generation unit
115: data transmission unit
200: control center
211: data extraction unit
212: image analysis unit
213: location calculation unit
214: feature extraction unit
215: data generation unit
216: data transmission unit

What is claimed is:

1. A system for tracking dangerous situation comprising:
a first surveillance device installed in a predetermined surveillance area, obtaining image data relating to a target causing dangerous situation and providing the obtained image data; and
a control center receiving the image data from the first surveillance device, and when it is determined based on the received image data that dangerous situation occurs, extracting feature data from the image data and transmitting metadata including the extracted feature data to at least one second surveillance device located on neighboring surveillance areas.

2. The system of claim 1, wherein the first surveillance device and the second surveillance device comprise at least one of a surveillance camera and a mobile device capable of obtaining image data.

3. The system of claim 1, wherein the first surveillance device, when the image data within the surveillance area is obtained, provides the obtained image data and its location information to the control center.

4. The system of claim 3, wherein the location information comprise at least one of global positioning system (GPS) location information and an identifier to identify the surveillance area.

5. The system of claim 4, wherein the control center, when it is determined that the dangerous situation occurs,
calculates the neighboring surveillance areas where the target may move based on the location information of the first surveillance device,
extracts feature data from the extracted image data, and
transmits metadata including the extracted feature data to the second surveillance device located on the neighboring surveillance areas.

6. The system of claim 5, wherein the second surveillance device, when the metadata is received from the control center,
extracts feature data from the received metadata and
determines if the extracted feature data is present in currently inputted image data.

7. The system of claim 6, wherein the second surveillance device, when it is determined that the extracted feature data is present in the currently inputted image data,
generates detection result data including current location information and the image data in which the feature data is present and
transmits the generated detection result data to the control center to inform that the target has moved to the corresponding surveillance area.

8. The system of claim 7, wherein the detection result data comprises a numerical value representing congruence or degree of similarity with the feature data to determine if the feature data is present or not.

9. A method for tracking dangerous situation comprising:
providing image data relating to a target causing dangerous situation within a predetermined surveillance area in which the image data is obtained by a first surveillance device installed in the predetermined surveillance area; and
transmitting, when a control center receives the image data from the first surveillance device, determines based on the received image data if dangerous situation occurs, and extracts feature data from the image data when it is determined that dangerous situation occurs, metadata including the extracted feature data to at least one second surveillance device located on neighboring surveillance areas.

10. The method of claim 9, wherein the first surveillance device and the second surveillance device comprise at least one of a surveillance camera and a mobile device capable of obtaining image data.

11. The method of claim 10, wherein the providing of the image data relating to the target, when the image data within the surveillance area is obtained, comprises providing the obtained image data and its location information to the control center.

12. The method of claim 11, wherein the location information comprises at least one of global positioning system (GPS) location information and an identifier to identify a surveillance area.

13. The method of claim 12, wherein the transmitting, when it is determined that the dangerous situation occurs, comprises:
calculating neighboring surveillance areas where the target may move,
extracting feature data from the extracted image data, and
transmitting metadata including the extracted feature data to the second surveillance device located on the neighboring surveillance areas.

14. The method of claim 13, further comprising:
receiving, by the second surveillance device, the metadata from the control center and extracting feature data from the received metadata and
determining, by the second surveillance device, if the extracted feature data is present in currently inputted image data.

15. The method of claim 14, further comprising:
generating, by the second surveillance device, detection result data including current location information and the image data in which the feature data is present, when it is determined that if the extracted feature data is present in currently inputted image data; and
transmitting the generated detection result data to the control center to inform that the target has moved to the corresponding surveillance area.

16. The method of claim 15, wherein the detection result data comprises a numerical value representing congruence or degree of similarity with the feature data to determine if the feature data is present or not.
